(19) United States
(12) Patent Application Publication
(10) Pub. No.: US 2016/0267422 A1
(43) Pub. Date: Sep. 15, 2016

(54) SYSTEM AND METHOD FOR FACILITATING SOCIAL RECOGNITION OF AGENTS

(71) Applicant: 24/7 Customer, Inc., Campbell, CA (US)

(72) Inventors: Aditya Anil KOTHADIYA, Fremont, CA (US); Pallipuram V. KANNAN, Saratoga, CA (US)

(21) Appl. No.: 15/059,201

(22) Filed: Mar. 2, 2016

Related U.S. Application Data
(60) Provisional application No. 62/131,206, filed on Mar. 10, 2015.

(51) Int. Cl. G06Q 10/06; G06Q 50/00; G06Q 30/02

(52) U.S. Cl. CPC G06Q 10/06398; G06Q 30/0282; G06Q 50/01

(57) ABSTRACT

A computer-implemented method and a system facilitate social recognition of agents. A first user interface (UI) is presented to a customer on a device in proximity to the customer subsequent to a completion of an interaction of the customer with an agent. The first UI comprises one or more survey questions related to a performance of the agent. A determination of whether the performance of the agent satisfies a predetermined condition is performed based on an input received from the customer in response to the one or more survey questions. A second UI is presented to the customer to request the customer to provide an endorsement for the agent if the performance of the agent satisfies the predetermined condition. A posting of the endorsement on one or more social media profiles of the agent is effected upon receiving the endorsement for the agent from the customer.

### CROSS REFERENCE TO RELATED APPLICATIONS

This application claims priority to U.S. provisional patent application Ser. No. 62/131,206, filed Mar. 10, 2015, which is incorporated herein in its entirety by this reference thereto.

### TECHNICAL FIELD

The invention generally relates to enabling interaction with customer service personnel and providing control of presentation or display data during such customer service related activities.

### BACKGROUND

Customer service and support is a vital component for success of any enterprise and often a differentiating factor between competing enterprises. As a result, many enterprises nowadays deploy personnel for providing service and support related assistance to their customers. Such personnel are referred to herein as customer support representatives or agents. The agents are equipped to interact with the customers for responding to their enquiries, resolving their concerns and in general assisting the customers as per their respective needs.

Current solutions for encouraging agents rely on assessing performance of the agents based on collated customer feedbacks relevant to the agent, and providing promotions and financial appraisals based on their performance assessment. Typically, such solutions are found to severely lack in their ability to motivate the agents and improve their performances.

Accordingly, there is a need to motivate agents engaged in customer service and support related activities. Moreover, there is a need to utilize positive customer experiences with agents in an intuitive way to motivate the agents.

### SUMMARY

In an embodiment of the invention, a computer-implemented method for facilitating social recognition of agents is disclosed. The method causes, by a processor, a display of a first user interface (UI) on a device in proximity to a customer subsequent to a completion of an interaction of the customer with an agent. The first UI includes one or more survey questions related to a performance of the agent during the interaction. The method receives, by the processor, at least one input from the customer in response to the one or more survey questions. The method determines, by the processor, whether the performance of the agent satisfies a predetermined condition based on the at least one input. The method causes, by the processor, a display of a second UI on the device if the performance of the agent is determined to be satisfying the predetermined condition. The second UI includes content requesting the customer to provide an endorsement for the agent for subsequent sharing of the endorsement on one or more social media profiles maintained by the agent. The method effects, by the processor, a posting of the endorsement on the one or more social media profiles upon receiving the endorsement for the agent from the customer.

In another embodiment of the invention, a system for facilitating social recognition of agents includes at least one processor and a memory. The memory stores machine executable instructions therein, that when executed by the at least one processor, causes the system to cause a display of a first user interface (UI) on a device in proximity to a customer subsequent to a completion of an interaction of the customer with an agent. The first UI includes one or more survey questions related to a performance of the agent during the interaction. The system receives at least one input from the customer in response to the one or more survey questions. The system determines whether the performance of the agent satisfies a predetermined condition based on the at least one input. The system causes a display of a second UI on the device if the performance of the agent is determined to be satisfying the predetermined condition. The predetermined conditions include, for example, where the customer has indicated performance or satisfaction of agent's assistance above a specified threshold. Indication of performance or satisfaction can indicated by various means including a rating entered at the end of the interaction or during a survey. The second UI includes content requesting the customer to provide an endorsement for the agent for subsequent sharing of the endorsement on one or more social media profiles maintained by the agent. The system effects a posting of the endorsement on the one or more social media profiles upon receiving the endorsement for the agent from the customer.

In another embodiment of the invention, a non-transitory computer-readable medium storing a set of instructions that when executed cause a computer to perform a method for facilitating social recognition of agents is disclosed. The method executed by the computer causes a display of a first user interface (UI) on a device in proximity to a customer subsequent to a completion of an interaction of the customer with an agent. The first UI includes one or more survey questions related to a performance of the agent during the interaction. The method receives at least one input from the customer in response to the one or more survey questions. The method determines whether the performance of the agent satisfies a predetermined condition based on the at least one input. The method causes a display of a second UI on the device if the performance of the agent is determined to be satisfying the predetermined condition. The second UI includes content requesting the customer to provide an endorsement for the agent for subsequent sharing of the endorsement on one or more social media profiles maintained by the agent. The method effects a posting of the endorsement on the one or more social media profiles upon receiving the endorsement for the agent from the customer.

### BRIEF DESCRIPTION OF THE FIGURES

FIG. 1 is an example representation showing customers engaged in interactions with customer support representatives of an enterprise, in accordance with an example scenario;

FIG. 2 is a block diagram of a system configured to facilitate social recognition of agents, in accordance with an embodiment of the invention;

FIG. 3 shows a user interface (UI) of a chat console displaying an on-going chat interaction between a customer and an agent, in accordance with an example scenario;

FIG. 4 shows a first UI displayed to a customer upon completion of an interaction between an agent and a customer, in accordance with an embodiment of the invention;

FIG. 5 shows a first UI displayed to a customer upon completion of an interaction between an agent and a customer, in accordance with another embodiment of the invention;

FIG. 6 shows a second UI displayed to a customer, in accordance with another embodiment of the invention;

FIG. 7 shows a third UI presented to a customer for linking an endorsement for an agent to a customer's social media profile, in accordance with an embodiment of the invention;

FIG. 8 shows a fourth UI corresponding to a social media profile of an agent subsequent to posting of one or more customer endorsements, in accordance with an embodiment of the invention;

FIG. 9 is a flow diagram of an example method for facilitating social recognition of agents, in accordance with an embodiment of the invention; and

FIG. 10 is a flow diagram of an example method for facilitating social recognition of agents, in accordance with another embodiment of the invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

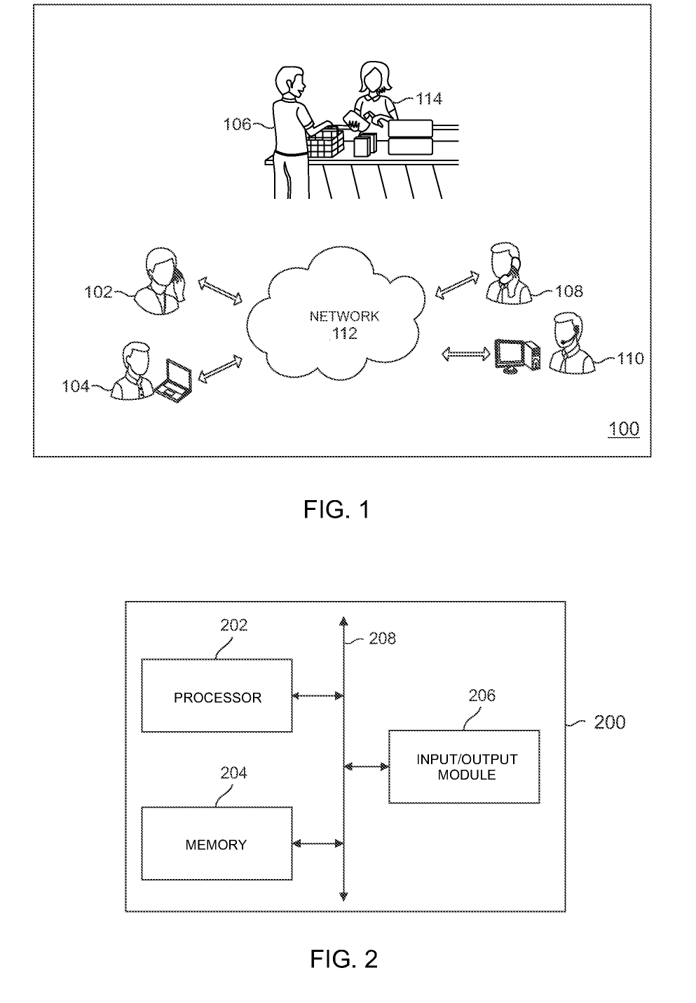

FIG. 1 is an example representation 100 showing customers engaged in interactions with customer support representatives of an enterprise, in accordance with an example scenario. The term ‘enterprise’ as used herein may refer to a corporation, an institution, a small/medium sized company or even a brick and mortar entity. For example, the enterprise may be a banking enterprise, an educational institution, a financial trading enterprise, an aviation company, a retail outlet or any such public or private sector enterprise. It is understood that the enterprise may be associated with a plurality of users of products, services and/or information offered by the enterprise. The existing and/or potential users of the enterprise offerings are referred to herein as customers of the enterprise. The example representation 100 depicts three customers of an enterprise: a customer 102, a customer 104 and a customer 106 for illustration purposes. It is understood that the enterprise may be associated with many such customers, such as the customers 102, 104 and 106.

Typically, most enterprises apart from seeking to successfully fulfill needs of potential and existing customers, also aspire to provide their customers with an effortless interaction experience. To that effect, many enterprises deploy human and virtual customer support representatives (hereinafter referred to as ‘agents’) to provide sales and service support to their customers. In an illustrative example, the enterprise may be associated with a customer support center, which may include several agents, such as an agent 108 and an agent 110, who are capable of providing remote assistance to the customers of the enterprise. The customer support center may additionally include virtual agents, such as chat bots for example, for assisting the customers. In some example scenarios, the customer support center may also include interactive voice response (IVR) systems and other web or digital self-assist systems for providing remote assistance to the customers.

Typically, the customers of the enterprise may initiate interaction with the agents, such as the agents 108 and 110, for a variety of purposes, such as for example, to enquire about billing or payment, to configure a product or troubleshoot an issue related to a product, to enquire about upgrades, to enquire about shipping of a product, to provide feedback, to register a complaint, to follow up about a previous query and the like. In an example scenario, a customer may utilize one or more personal devices to engage in an interaction with an agent. Some non-limiting examples of the personal devices may include a desktop computer, a mobile phone, a Smartphone, a laptop, a tablet device, a personal digital assistant, a wearable device such as a Smart watch, and the like. In the example representation 100, the customer 102 is depicted to utilize a mobile phone to engage in a phone call interaction with the agent 108. It is noted that an enterprise customer may utilize interaction channels other than the voice channel for interacting with an agent. In an illustrative example, the customer 104 is depicted to utilize a personal computer to engage in a chat interaction (i.e. use a chat channel for interaction) with the agent 110. In some example scenarios, a customer may visit an enterprise website (i.e. use a web channel) to make an enquiry for a recent purchase or troubleshoot an issue related to a product. It is understood that one or more of such interaction channels may be accessed using a communication network, such as a network 112. Examples of the network 112 may include wired networks, wireless networks or a combination thereof. Examples of wired networks may include Ethernet, local area networks (LAN), fiber-optic cable networks and the like. Examples of wireless network may include cellular networks like GSM/3G/4G/CDMA based networks, wireless LANs, Bluetooth or Zigbee networks and the like. An example of a combination of wired and wireless networks may include the Internet. It is noted that in some cases, the customers may preclude interaction with the agents over interaction channels and may instead engage in a face-to-face interaction with the agents. In the example representation 100, an agent 114 deployed in a retail outlet is depicted to be engaged in a face-to-face interaction with the customer 106.

In addition to deploying agents for engaging in customer support and service related activities, many enterprises also implement mechanisms for monitoring quality of service afforded to its customers to evaluate a satisfaction quotient of the customers. Typically, the customers are requested to fill-up short survey forms for outlining their interaction experiences with the agents. In many cases, the survey forms include simple questions, which require their customers to respond with a ‘Yes’ or a ‘No’ input or in some cases provide a click input to indicate a number of stars for rating the performance of the agent. In some example scenarios, the customers may even add a positive or a negative comment in the survey form to convey their feelings regarding their customer service experience.

Typically, all customer survey responses and/or feedback are collated for each agent and used for assessing a performance of the agent. Further, promotions and/or financial appraisals may be provided to agents based on the assessment of their respective performances. Typically, such solutions are found to severely lack in their ability to motivate agents and improve their performances. Moreover, periodic assessments are also limited in their ability to influence daily interactions. There is a need to motivate agents engaged in customer service and support related activities and improve their performances. Moreover, there is a need to utilize positive customer experiences with agents in an intuitive way to motivate the agents.

Various embodiments of the present technology provide a system and a method that are capable of overcoming these and other obstacles and providing additional benefits. More specifically, the system and the method disclosed herein suggest posting customer endorsements on social media profiles of the agents for motivating the agents. Favorable customer endorsements are shared in substantially real-time on an agent's social network and as such the endorsements are visible to family, friends and acquaintances of the agent, thereby motivating the agent. Moreover, such real-time endorsements encourage the agents to do better in subsequent interactions as opposed to conventional techniques, which rely on periodic evaluations and appraisals for motivating the agents. An example system for facilitating social recognition of agents is explained with reference to FIG. 2.

FIG. 2 is a block diagram of a system 200 configured to facilitate social recognition of agents, in accordance with an embodiment of the invention. As explained with reference to FIG. 1, the term ‘enterprise’ may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise.

The term ‘agents’ as used hereinafter may refer to personnel engaged in customer support and service related activities either remotely such as from customer support centers, or, personnel who are deployed at enterprise locations, such as retail outlets, merchant establishments etc., or in some cases, personnel who are deployed at customer locations or travel to customer locations (such as a salesman or on onsite handyman, etc.). Furthermore, the term ‘facilitating social recognition of agents’ as used herein refers to posting customer endorsements of agents on their respective social media profiles so as to enable recognition or appreciation of agent's work among the agent's social circle including family, friends and acquaintances of the agent. It is understood that such social recognition of agents may motivate the agents and in turn improve the agent's performance in conducting interactions with customers and assisting the customers in meeting their respective needs.

The term ‘customers’ as used herein may refer to both existing and potential users of products, services or information offered by the enterprise. In many example scenarios, the term customers may refer to a person or a group of persons interacting with one or more agents either directly and/or using automated or semi-automated means over a plurality of interaction channels, such as a voice channel, a chat channel, a native mobile application channel, a web/online channel, a social media channel and the like.

The system 200 includes at least one processor, such as a processor 202 and a memory 204. It is noted that although the system 200 is depicted to include only one processor, the system 200 may include more number of processors therein. In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The system 200 also includes an input/output module 206 (hereinafter referred to as ‘I/O module 206’) for providing an output and/or receiving an input. The I/O module 206 is configured to be in communication with the processor 202 and the memory 204. Examples of the I/O module 206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

In an embodiment, the I/O module 206 may be configured to provide a user interface (UI) configured to enable enterprises to utilize the system 200 for facilitating social recognition of agents. Furthermore, the I/O module 206 may be integrated with a monitoring mechanism configured to provide the enterprises with real-time updates/alerts (for example, email notifications, SMS alerts, etc.) of changes to be made to the system 200 for motivating the agents.

In an embodiment, the I/O module 206 may include one or more transceivers configured to facilitate to and from communication with remote web servers. The remote web servers in turn may be configured to be communicably associated with devices associated with the agents, such that the remote web servers may receive information related to agent interactions with customers in substantially real-time. For example, the remote web servers may be configured to track an on-going chat interaction or a voice interaction between an agent and a customer and provision such information to the I/O module 206. In some example embodiments, the devices associated with the agents may correspond to mobile hand-held devices (such as for example, electronic devices provisioned to agents such as a salesman etc.) or fixed devices deployed at enterprise outlets, such as retail stores, restaurants, ticketing counters, etc.

In some embodiments, the remote web servers may be configured to track customer activity on enterprise websites. For example, the web servers may be configured to track website access by customers by way of tracking cookies (for example, web browser cookies) and/or tags, such as hypertext markup language (HTML) tags or JavaScript tags associated with the web pages of the website. In some cases, the web servers may also be capable of opening up a socket connection for an on-going customer journey on the website to capture data related to customer activity on the website. For example, the web servers may capture information related to an on-going chat conversation between an agent and a customer on an enterprise website. The I/O module 206 may be configured to receive information captured in such a manner from the remote web servers.

The I/O module 206 may further be configured to effect display of various user interfaces on remote devices. The remote devices may be customer-owned or customer-associated devices, or in some cases, may be devices that are enterprise owned, such as those in retail outlets or personal screens in aircrafts, or in some cases may be public devices, such as devices deployed in public trains, parks, washrooms etc. In at least one example embodiment, the I/O module 206 may be configured to be in communication with device application programming interfaces (APIs) so as to push content such as survey forms and receive customer response from the remote devices.

In an embodiment, various components of the system 200, such as the processor 202, the memory 204 and the I/O module 206 are configured to communicate with each other via or through a centralized circuit system 208. The centralized circuit system 208 may be various devices configured to, among other things, provide or enable communication between the components (202-206) of the system 200. In certain embodiments, the centralized circuit system 208 may be a central printed circuit board (PCB) such as a motherboard, a main board, a system board, or a logic board. The centralized circuit system 208 may also, or alternatively, include other printed circuit assemblies (PCAs) or communication channel media.

It is understood that the system 200 as illustrated and hereinafter described is merely illustrative of a system that could benefit from embodiments of the invention and, therefore, should not be taken to limit the scope of the invention. It is noted that the system 200 may include fewer or more components than those depicted in FIG. 2. In an embodiment, the system 200 may be embodied as a platform including a mix of existing open systems, proprietary systems and third party systems. In another embodiment, the system 200 may be implemented completely as a platform including a set of software layers on top of existing hardware systems. In an exemplary scenario, the system 200 may be any machine capable of executing a set of instructions (sequential and/or otherwise) so as to facilitate social recognition of agents. Moreover, the system 200 may be implemented as a centralized system, or, alternatively, the various components of the system 200 may be deployed in a distributed manner while being operatively coupled to each other.

In an embodiment, functionalities of the system 200 may also be embodied as a client within devices, such as agent devices or devices deployed at enterprise locations or public places. In another embodiment, the system 200 may be a central system that is shared by or accessible to each of such devices.

The facilitating of social recognition of agents is explained hereinafter with reference to one agent. It is understood social recognition of several agents of the enterprise may be facilitated in a similar manner.

In an embodiment, the processor 202 is configured to, with the content of the memory 204, cause the system 200 to request each agent associated with the enterprise to register one or more social media profiles with the system 200. Some non-limiting examples of social media profiles maintained by an agent may include a Facebook™ profile, a Google+™ profile, a Twitter™ profile, a LinkedIn™ profile and the like. The registration of the one or more social media profiles may be performed at an initial stage, for example when the agent initiates association with the enterprise or more specifically, when the agent joins the enterprise. The registration process may involve seeking approval from the agent to post content such as endorsements on the agent's social media profiles. In an embodiment, the registered social media profiles for each agent along with the approvals for posting customer endorsements may be stored in the memory 204. In an embodiment, such information may be assigned labels or tags, such as an agent id or an agent name for linking agents with respective stored information. In an embodiment, the system 200 may further be caused to authenticate the pre-approved one or more social media profiles maintained by the agent prior to posting of an endorsement for the agent. In some example embodiments, the registration of the social media accounts as well as the approvals may be authenticated at pre-specified intervals, such as for example on a weekly or a monthly basis.

In an embodiment, the processor 202 is configured to, with the content of the memory 204, cause the system 200 to cause a display of a first user interface (UI) on a device in proximity to a customer subsequent to a completion of an interaction of the customer with an agent. It is understood that the term ‘interaction’ as used herein refers to a conversation, such as an interactive online chat conversation, a telephonic conversation or a face-to-face voice conversation, between a customer and the agent. As explained earlier, the I/O module 206 may be configured to be communicably associated with remote web servers, agent devices and/or personal devices of the customer. In at least one example embodiment, an interaction activity related to an interaction between a customer and an agent may be tracked by the system 200 (for example, by using the communication link between the I/O module 206 and the APIs in agent/customer devices) to deduce if the interaction is completed or not. In many example scenarios, speech utterances like ‘Thank you for your time’ or ‘bye’ etc., may be tracked to determine whether an interaction between the agent and the customer has been completed or not. In some example scenarios, the agent may select a pre-configured script line (for example, ‘Is there anything else I can assist you with today’) while ending a chat interaction. The system 200 may be configured to track a selection of such a script line to determine completion of an interaction. In cases where the agent is engaged in a face-to-face interaction with the customer, the agent may provide a signal to the system 200 indicating a completion of the interaction. For example, the agent may select a menu option on the agent device to indicate completion of the interaction.

Accordingly, upon completion of an interaction between an agent and the customer, the first UI may be displayed on the device in proximity to the customer. It is noted that the device in proximity to a customer may be a customer-affiliated device, a public display device, an agent device or even an electronic device deployed at an enterprise location. In an illustrative example, upon completion of a chat conversation between an agent and a customer, the first UI may be displayed on a customer's device being used by the customer for engaging in the chat interaction with the agent. In an example scenario, the first UI may be displayed within the chat console being displayed on the customer's device. In another illustrative device, the upon completion of a phone call conversation between an agent and a customer, the first UI may be displayed on a customer's Smartphone being used by the customer for engaging in the phone interaction with the agent. In yet another illustrative example, upon completion of an interaction between an agent and a customer in an enterprise retail store, the first UI may be displayed on an electronic device deployed at the entrance/exit of the enterprise retail store. It is noted that in some example embodiments, the system 200 may be configured to provision a link, such as for example a web link, to the customer over an email channel or a chat channel upon completion of the interaction so as to enable the customer to view the first UI at a convenient time for the user.

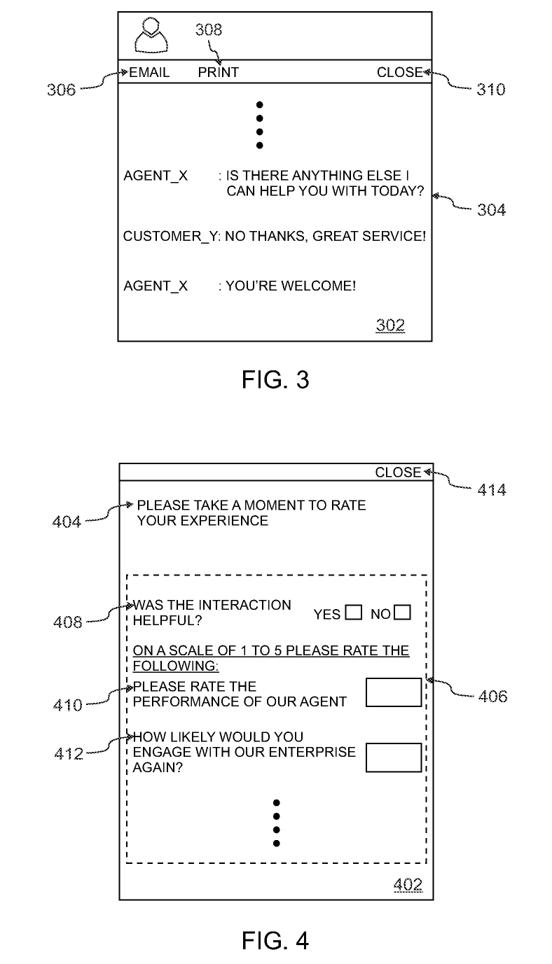

In at least one example embodiment, the first UI displayed on the device in proximity to the customer includes one or more survey questions related to a performance of the agent during the interaction. In an embodiment, at least one survey question corresponds to rating a performance of the agent on a preconfigured performance scale. An example of the preconfigured performance scale may be a scale including values configuring a range, where the lowest value in the range may be associated with poorest performance rating and the highest value in the range may be associated with an excellent rating. In another illustrative example, the preconfigured performance scale may refer to a five star rating, where one star rating may suggest poor performance and five star rating may suggest excellent performance by the agent. The detection of the completion of an interaction between an agent and a customer and a subsequent provisioning of a first UI on a device in proximity to the customer is further explained with reference to illustrative examples in FIGS. 3 and 4.

Referring now to FIG. 3, a user interface (UI) 302 of a chat console 304 displaying an on-going chat interaction between a customer and an agent is shown, in accordance with an example scenario. It is understood that the term ‘chat console’ as used herein refers to a box or an area displayed on a screen of an electronic device to facilitate an interactive textual conversation between an agent and a customer. In at least one example scenario, the chat console 304 may be displayed within an UI corresponding to an Internet browser application being utilized by a customer to access websites. In an illustrative scenario, a customer may utilize the Internet browser application installed on the customer's electronic device (for example, a laptop, a mobile phone, a Smartphone, a tablet computer etc.) to access an enterprise website. In some example scenarios, the customer may be offered with an option to chat with an agent while browsing through one or more web pages on the enterprise website. Alternatively, the customer may select a ‘click to chat’ (or in some cases click to call) widgets being displayed on each web page of the enterprise website to seek assistance from an agent. In an example scenario, upon accepting the offer to chat with an agent, a chat console, such as the chat console 304 may be displayed on the website. The customer may thereafter chat with the agent to address his or her specific need.

The UI 302 of the chat console 304 is depicted to display a portion of an ongoing chat conversation (also referred to herein as a chat interaction) between the agent and the customer. It is understood that conversational lines from the agent are appended with agent identification (exemplarily depicted herein as Agent_X), whereas the conversational lines from the customer are appended with a customer identification (exemplarily depicted herein as ‘Customer_Y’). It is understood that such a representation of agent and customer identifications is included herein for illustration purposes and that the identification of the agent and/or the customer may be implemented to display a name, a pen name, a numerical id, etc. of the respective chatting entities.

The chat console 304 further depicts menu options, such as ‘Email’ 306, ‘Print’ 308 and ‘Close’ 310 indicative of options to email the chat interaction (for example, to a registered customer mailing ID), to print the chat interaction, and to close the chat console 304 for terminating the chat interaction, respectively. The customer may utilize any of these options during the course of the chat interaction to achieve their respective functions.

In an embodiment, the system 200 may be caused to determine a completion of the interaction based on the content of the chat dialogue. For example, when the agent enquires ‘Is there anything else I can help you with today?’ and when the customer responds with ‘No, thanks, great service!’, and the agent replies saying ‘You're welcome!’, then such utterances may be analyzed (for example, compared with known closing utterances) by the system 200 to determine that the interaction is completed. As explained with reference to FIG. 2, the completion of the interaction between the agent and the customer may be detected in various ways by the system 200. For example, a termination of a phone call conversation between an agent and the customer may be tracked to detect a completion of the interaction. In another illustrative example, an agent may indicate a completion of a face-to-face interaction with a customer. Further, as explained with reference to FIG. 2, the system 200 may be configured to cause a display of the first UI on the device in proximity to the customer upon completion of the interaction between the agent and the customer. An example first UI displayed to the customer is depicted in FIG. 4.

FIG. 4 shows a first UI 402 displayed to a customer upon completion of an interaction between an agent and a customer, in accordance with an embodiment of the invention. It is understood that the first UI 402 may be displayed within a chat console, such as the chat console 304 explained with reference to FIG. 3 upon completion of the chat interaction between the customer and the agent. However, the display of the first UI 402 may not be limited to chat consoles. In an illustrative scenario, the first UI 402 may be displayed on a device associated with an agent (such as for example, an agent visiting the customer's premise). Upon completion of the face-to-face interaction, the agent may indicate a completion of the interaction to the system 200, which may then be caused to present the first UI 402 on the device. In another example scenario, the first UI 402 may be displayed on an electronic device deployed at an enterprise location, such as for example a retail store or at a ticketing/billing counter. Upon completion of the interaction (for example, an interaction related to a purchase of a product or conclusion of a ticketing/billing process), the first UI 402 may be displayed on the electronic device to elicit feedback of the agent's performance during the customer interaction with the agent.

In an example embodiment, the first UI 402 may be configured to display a text portion 404 including text, such as for example, ‘Please take a moment to rate your experience’. The first UI 402 may further include a survey form 406 including multiple survey questions for the customer. In an example embodiment, the survey form 406 may include questions, which may elicit a ‘Yes’ or a ‘No’ response, such as for example a question 408 querying the customer if the interaction was helpful or not. The customer may click in an appropriate box to provide a response to such a question. Additionally, or alternatively, the survey form 406 may include questions, such as a question 410, requesting the customer to rate the agent's performance on a scale of ‘one to five’ (for example, a rating of ‘one’ implying poor performance and a rating of ‘five’ implying excellent performance), or a question 412 asking the customer to rate how likely would the customer engage with the enterprise again on a scale of ‘one to five’. It is understood that the customer may choose not to respond to the survey questions and as such may select a menu option 414 displaying text ‘close’ for closing the first UI 402 and terminating the interaction.

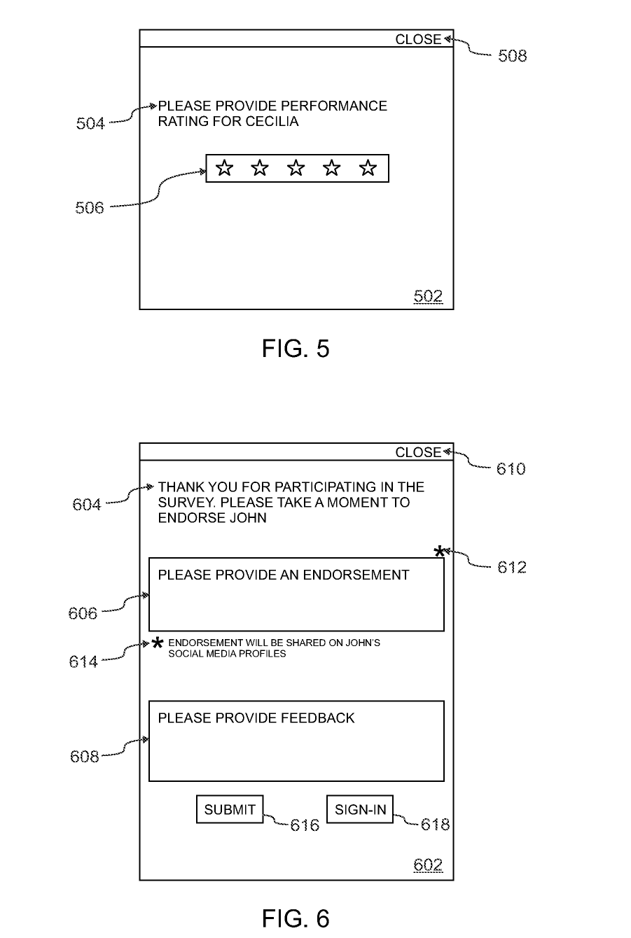

In at least one embodiment, the survey questions are chosen such that they facilitate generation of at least one score from among a net promoter score (NPS), a net experience score (NES) and a customer satisfaction (CSAT) score. Each of these scores may be based on the ratings provided by the customer during the survey. Such scores may enable determination of a satisfaction level of the customer and in turn enable assessing an agent's performance during the interaction. In some embodiments, the survey form 406 may include only one question requesting the customer to provide a star rating on a scale of one to five stars to rate the agent's performance as exemplarily depicted in FIG. 5.

Referring now to FIG. 5, a first UI 502 displayed to a customer upon completion of an interaction between an agent and a customer is shown, in accordance with another embodiment of the invention. In an illustrative example, the agent is exemplarily depicted to be Cecilia. The first UI 502 depicts a text portion 504 requesting the customer to rate Cecilia's performance. Moreover, a scale 506 including five stars is depicted below the text portion 504. The customer may click on an appropriate number of stars to indicate the rating for Cecilia's performance. In an embodiment, a selection of one star may be equivalent to providing a low rating for agent's performance and a selection of five stars may be equivalent to providing the highest rating for the agent's performance.

In some embodiments, the customer may be requested to individually rate various aspects of the agent's performance, such as for example, greetings, problem-solving skills, general interaction skills etc., as opposed to providing a single rating for the agent's performance as depicted by the scale 506. It is understood that the customer may choose not to respond to the survey questions and as such may select a menu option 508 displaying text ‘close’ for closing the first UI 502 and terminating the interaction.

Referring back to FIG. 2, in at least one embodiment, the processor 202 is configured to, with the content of the memory 204, cause the system 200 to receive at least one input from the customer in response to the one or more survey questions. More specifically, the I/O module 206 of the system 200 may receive input such as a ‘Yes’ or a ‘No’ input or a numerical value input or a star rating input. Further, in at least one embodiment, the processor 202 is configured to, with the content of the memory 204, cause the system 200 to determine whether the performance of the agent satisfies a predetermined condition based on the input provided by the customer in response to the one or more survey questions. It is noted that the term ‘predetermined condition’ as used herein refers to a necessary requirement to be met to determine if the performance of the agent is a favorable performance or not. More specifically, a customer rating for the agent's performance not satisfying the predetermined condition indicates that the customer has provided a negative rating of the agent, whereas a customer rating for the agent's performance satisfying the predetermined condition indicates that the customer has provided a positive rating of the agent.

In an illustrative example, the system 200 may be caused to compute a score such as for example, a NPS, a NES or a CSAT score based on the input provided by the customer in response to the survey questions provisioned to the customer on the first UI, such as the first UI 402. The computed score (or scores) may be compared to predefined threshold value, such as for example a numerical value of 80 (on a 1 to 100 value scale). In such a case, determining whether the performance of the agent satisfies the predetermined condition includes determining if the computed score is greater than the predefined threshold value (i.e. the numerical value of 80). For example, if the computed score corresponding to the agent's performance during the interaction with the customer is 60 then the system 200 may be caused to determine that the agent's performance does not satisfy the predetermined condition as the computed score is less than the predefined threshold value of 80.

In another illustrative example, the first UI may display only questions related to star ratings (for example, one to five star ratings). In such a case, an overall star rating corresponding to the agent's performance may be computed by the system 200 and compared to an average agent rating on the preconfigured performance scale. For example, if the average agent rating on the preconfigured performance scale (such as a scale of one to five stars with one star suggestive of poor rating and five stars suggestive of highest rating) is three, then the overall star rating provided by the customer may be compared to three star rating. If the customer rating for the agent's performance is four or five, then the system 200 may be caused to determine that the agent's performance satisfies the predetermined condition.

In an embodiment, the processor 202 is configured to, with the content of the memory 204, cause the system 200 to cause a display of a second UI on the device if the performance of the agent is determined to satisfy the predetermined condition. More specifically, if the agent's performance is determined to satisfy the predetermined condition or, in other words, the agent's performance is determined to be favorable, then the system 200 is caused to present a second UI to the customer on the customer device. In at least one example embodiment, the second UI may include content requesting the customer to provide an endorsement for the agent, which may then be subsequently shared on one or more social media profiles maintained by the agent.

In an example embodiment, the second UI may include a first free-flow text area capable of receiving a textual input related to the endorsement from the customer. Further, in at least one example embodiment, the system 200 may be caused to request the customer to link the endorsement to a respective social media profile of the customer prior to posting the endorsement on the one or more social media profiles of the agent. The endorsement posted on the one or more social media profiles of the agent is linked to the respective social media profile of the customer upon receiving an acceptance from the customer for linking the endorsement to the respective social media profile of the customer. In an embodiment, the posted endorsement is associated with a tag indicative of an anonymous customer if the customer rejects the request for linking the endorsement to the respective social media profile of the customer. In an embodiment, the endorsement posted on the one or more social media profiles of the customer comprises a star based rating for the agent. In some embodiments, the second UI may include a second free-flow text area capable of receiving a textual input related to feedback for the agent from the customer. An example second UI displayed to the customer is depicted in FIG. 6.

Referring now to FIG. 6, a second UI 602 displayed to a customer is shown, in accordance with another embodiment of the invention. As explained with reference to FIG. 2, a second UI is displayed to the customer on a device in proximity to the customer (for example, the device on which the first UI was displayed) if the performance of the agent is determined to satisfy the predetermined condition. The second UI includes content requesting the customer to provide an endorsement for the agent, such that the endorsement may subsequently be shared on one or more social media profiles maintained by the agent.

Accordingly, the second UI 602 includes a text portion 604 prompting the customer to provide an endorsement for the agent. In an illustrative example, the text portion 604 may include text such as ‘Thank you for participating in the survey. Please take a moment to endorse John’ (where, John is the agent who has provided assistance to the customer). In an embodiment, the second UI 602 further includes a first free flow text area 606 and a second free flow text area 608 capable of receiving input from the customer. The customer input in the first free flow text area 606 may serve as an endorsement for the agent, whereas textual input in the second free flow text area 608 may be optional and may serve as a feedback for the agent. It is understood that the second UI 602 including the text portion 604, the first free flow text area 606 and the second free flow text area 608 is depicted herein for illustration purposes. Indeed in some embodiments, the second UI 602 may only include the text portion 604 and the first free flow text area 606 for receiving endorsement from the customer. Moreover, in an embodiment, the customer may choose to not provide the feedback and/or the endorsement and may end the interaction by selecting a menu option 610 displaying text ‘close’. Moreover, only the endorsement provided in the first free flow text area 606 may be shared on social media profiles of the agent (as will be explained later with reference to FIG. 8), whereas the feedback provided in the second free flow text area 608 may be used for internal training and evaluation purposes.

It is also noted that in most cases, the second UI 602 may be provisioned to the customer on the same device on which the first UI, such as the first UI 402 or the first UI 502 was provided. As explained with reference to FIGS. 4 and 5, the device may be any electronic device (for example, a Smartphone, a laptop, a tablet computer, a wearable device, a mobile phone, a desktop computer, etc.) in proximity to the customer and as such may be a customer-affiliated device, a device deployed in an enterprise location, an agent device or a public display device. In an embodiment, the second UI 602 corresponds to an interactive interface within a chat console such as the chat console 304 explained with reference to FIG. 3.

In an embodiment, the customer may provide words of appreciation for the agent in a textual form in the first free flow text area 606. In some cases, the customer may also be capable of inputting images or icons, such as a thumbs-up image indicative of a like symbol or even a star rating in the first free flow text area 606 in addition to the text. In at least one embodiment, an asterisk symbol ‘*’ may be provisioned at a suitable location near the first free flow text area 606, as exemplarily depicted by symbol 612 in the second UI 602 drawing attention of the customer to a text portion 614, which may inform the customer that the endorsement will be posted on the one or more social media profiles of the agent.

A submit option 616 may also be provisioned on the second UI 602 requesting the customer to provide permission to post the endorsement on the social media profiles of the agent. The customer may provide permission for posting the endorsement on the social media profiles of the agent by clicking or providing a touch input on the submit option 616. Alternatively, the customer may choose to skip provisioning and the subsequent posting of the endorsement by selecting the menu option 610 (for example, by clicking or providing a touch input) to close the second UI 602.

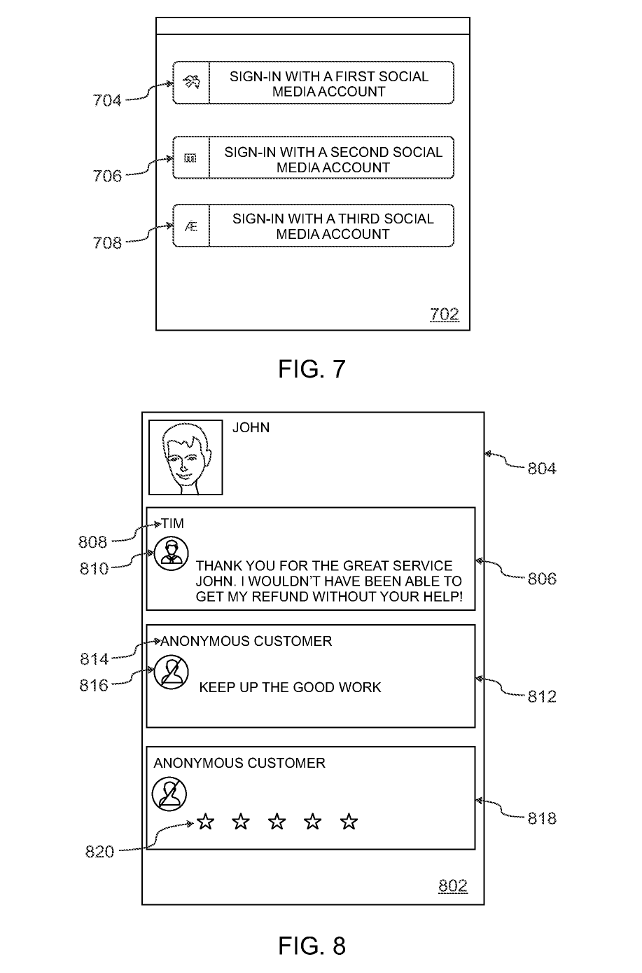

In an embodiment, the customer may also be requested to link the endorsement to a respective social media profile. In an illustrative example, if the agent has pre-approved Facebook™ and LinkedIn™ as social media profiles for posting endorsements, then the customer may be requested to sign-in, for example by clicking on a sign-in option 618 on at least one of these social media profiles so as to link the endorsement to their social media profiles. In at least one example embodiment, suitable incentives may be provided to the customer for taking such extra effort. For example, a promotional offer or a discount on next purchase may be offered to the customer for endorsing the customer and linking the endorsement to their respective social media profiles. In an embodiment, the linking of the social media profiles of the customer to the endorsements may be effected in an intuitive way without the customer having to separately access the respective social media account. For example, a UI may be provisioned to the customer subsequent to the display of the second UI 602 to enable the customer to sign-in into any one of the social media profiles maintained by the customer as exemplarily depicted in FIG. 7.

FIG. 7 shows a third UI 702 presented to a customer for linking an endorsement for an agent to a customer's social media profile, in accordance with an embodiment of the invention. The third UI 702 may be presented on the same device on which the second UI was presented to the customer. The third UI 702 depicts three buttons 704, 706 and 708 displaying text ‘Sign-in with a first social media account’, ‘Sign-in with a second social media account’ and ‘Sign-in with a third social media account’, respectively. In an illustrative example, the first, the second and the third social media accounts may correspond to any of a Facebook™, Twitter™, Google+™ LinkedIn™, Instagram™ accounts. In an example embodiment, only those social media account options may be presented to the customer for whom approval is provisioned by the agent. For example, if the agent has pre-approved the system 200 to post endorsements on Facebook™ and Twitter™, then options for logging into only two social media accounts may be presented to the customer to facilitate subsequent linking of the customer profile to the posted endorsement.

In an embodiment, the customer may provide a click or a touch input on any of the three buttons 704, 706 and 708 to select a social media account. In an embodiment, the system 200 may be caused to use API plug-ins of the social media accounts to redirect the customer from the third UI 702 to the respective social media page. The customer may sign-in to the respective media accounts and link the respective social media profiles of the customer to the endorsement. More specifically, the sign-in information may authenticate the customer and provide profile information (such as for example, profile name and profile picture) of the customer to the system 200 for linking the customer's profile to the endorsements to be posted on one or more social media profiles of the agent. In some embodiments, the system 200 may be caused to store customer social media account information along with sign-in information in the memory 204.

Referring now to FIG. 2, in an embodiment, the processor 202 is configured to, with the content of the memory 204, cause the system 200 to effect a posting of the endorsement on the one or more social media profiles of the agent. As explained with reference to FIGS. 6 and 7, if the customer chooses to link his or her profile to the endorsement, for example by logging into respective social media profile, then the endorsement may include the customer's social media profile information, for example customer's profile name and profile picture etc. However, if the customer chooses to provide an endorsement but not link his or her profile to the endorsement then the posted endorsement may be tagged with an ‘anonymous customer’ label as exemplarily depicted in FIG. 8.

FIG. 8 shows a fourth UI 802 corresponding to a social media profile 804 of an agent subsequent to posting of one or more customer endorsements, in accordance with an embodiment of the invention. As explained with reference to FIG. 2, an agent may pre-approve the system 200 to post customer endorsements on select social media profiles. Accordingly, the system 200 may be caused to effect a posting of customer endorsements on the selected social media profiles of the agent. Moreover, as explained with reference to FIGS. 6 and 7, if the customer chooses to link his or her respective social media profile to the endorsement, then the customer's profile information is included in the endorsement as exemplarily depicted on the social media profile 804. In an illustrative example, the social media profile 804 may correspond to a social media profile of an agent John. Further, John may have recently assisted a customer ‘Tim’ who may have liked the assistance provided by John and opted to endorse John. Moreover, Tim may have opted to link his social media profile to the endorsement. Accordingly, the system 200 may post an endorsement 806 including textual content ‘Thank you for the great service John. I wouldn't have been able to get my refund without your help’ on the social media profile 804 of John. Moreover, the endorsement 806 is configured to display Tim's name 808 and his profile picture 810 along with the textual content.

In some cases, the customer may choose not to link his or her respective social media profile to the endorsement. In such a case, the endorsement may be posted on the agent's social media profile along with the tag ‘anonymous customer’. In an illustrative example, agent John may have recently assisted a customer ‘James’ who may have liked the support provided by John and opted to endorse John. However, James may have opted not to link his social media profile to the endorsement. Accordingly, the system 200 may post the endorsement 812 including the textual content ‘Keep up the good work’ on the social media profile 804 of John. The endorsement 812 may be labeled with a tag 814 ‘anonymous customer’ and a grayscale image 816 suggestive of missing profile picture. In some cases, the customer may choose to include image content as exemplarily depicted in endorsement 818 showing an image 820 of five stars. It is understood that the image content may not be limited to stars and in some cases images of animated characters, such as clapping hands, etc., may also be provided as an endorsement.

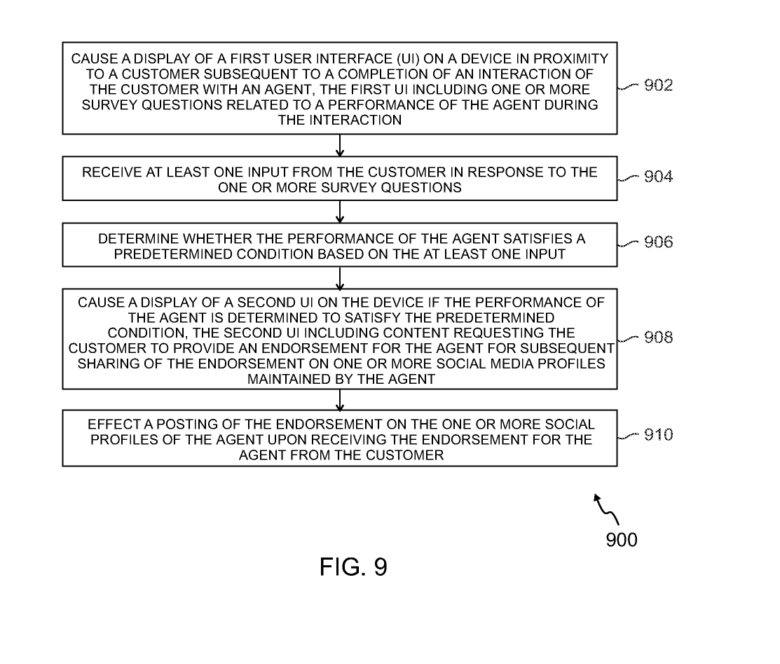

It is noted that such endorsements provided by the customers that are displayed on the social media profiles of the agents allow family, friends and other acquaintances of the agents to also recognize the good services being provided by the agents, and open the agents to more appreciation outside the workplace. The endorsements may further be liked, commented upon, or shared by family and friends on the social media profiles of the agent. Such increased level of appreciation and social recognition of agents' efforts and customer handling by people external to the enterprises may contribute to increasing the productivity of the agents at the workplaces associated with the enterprises. A method for facilitating social recognition of agents is explained with reference to FIG. 9.

FIG. 9 is a flow diagram of an example method 900 for facilitating social recognition of agents, in accordance with an embodiment of the invention. The method 900 depicted in the flow diagram may be executed by, for example, the system 200 explained with reference to FIGS. 2 to 8. Operations of the flowchart, and combinations of operation in the flowchart, may be implemented by, for example, hardware, firmware, a processor, circuitry and/or a different device associated with the execution of software that includes one or more computer program instructions. The operations of the method 900 are described herein with help of the system 200. For example, one or more operations corresponding to the method 900 may be executed by a processor, such as the processor 202 of the system 200. It is noted that although the one or more operations are explained herein to be executed by the processor alone, it is understood that the processor is associated with a memory, such as the memory 204 of the system 200, which is configured to store machine executable instructions for facilitating the execution of the one or more operations. It is also noted that, the operations of the method 900 can be described and/or practiced by using a system other than the system 200. The method 900 starts at operation 902.

At operation 902 of the method 900, a display of a first user interface (UI) is caused on a device in proximity to a customer subsequent to a completion of an interaction of the customer with an agent. In at least one example embodiment, an interaction activity related to an interaction between a customer and an agent may be tracked to deduce if the interaction is completed or not. The tracking and subsequent detection of completion of interaction may be performed as explained with reference to various illustrative examples in FIG. 2.

Accordingly, upon completion of an interaction between an agent and the customer, the first UI may be displayed on the device in proximity to the customer. As explained with reference to FIG. 2, the device in proximity to the customer may be a customer-affiliated device, a public display device, an agent device or even an electronic device deployed at an enterprise location. The first UI includes one or more survey questions related to a performance of the agent during the interaction. The causing of the display of the first UI may be performed as explained with reference to the first UI 402 and the first UI 502 in FIGS. 4 and 5, respectively, and is not explained herein.

At operation 904 of the method 900, at least one input is received from the customer in response to the one or more survey questions displayed in the first UI. In an example embodiment, the first UI may include a survey form containing questions, which may elicit a ‘Yes’ or ‘No’ response. The customer may click in an appropriate box to provide a response to such a question. Additionally, or alternatively, the survey form may include questions requesting the customer to rate the agent's performance on a scale of ‘one to five’ (for example, a rating of ‘one’ implying poor performance and a rating of ‘five’ implying excellent performance), or a question asking the customer to rate how likely would the customer engage with the enterprise again on a scale of ‘one to five’. In at least one embodiment, the survey questions are chosen so as to facilitate generation of a net promoter score (NPS), a net experience score (NES) and a customer satisfaction (CSAT) score. Such scores may enable determination of a satisfaction level of the customer and in turn help assess an agent's performance during the interaction. In some embodiments, the survey form may include only one question requesting the customer to provide a star rating on a scale of one to five stars to rate the agent's performance and the customer may provide an click or a touch input as a response to indicate his assessment of the agent's performance.

At operation 906 of the method 900, it is determined whether the performance of the agent satisfies a predetermined condition based on the at least one input. In an illustrative example, a score such as for example, a NPS, a NES or a CSAT score may be computed based on the input provided by the customer in response to the survey questions provisioned to the customer on the first UI. The computed score (or scores) may be compared to a predefined threshold value (or predefined threshold values), such as for example a value of 80 (on a 1 to 100 value scale). In such a case, determining whether the performance of the agent satisfies the predetermined condition or not includes determining if the score is greater than the predefined threshold value. For example, if the computed score corresponding to the agent's performance during the interaction with the customer is 60 then it may be determined that the agent's performance does not satisfy the predetermined condition as it is less than the predefined threshold value of 80. Similarly, in another illustrative example, an overall star rating corresponding to the agent's performance may be computed and compared to an average agent rating on the preconfigured performance scale. If the average agent rating on the preconfigured performance scale (such as scale of one to five stars with one star suggestive of poor rating and five stars suggestive of highest rating) is less than the overall star rating provided by the customer then it may be determined that the agent's performance satisfies the predetermined condition.

At operation 908 of the method 900, a display of a second UI is caused on the device if the performance of the agent is determined to satisfy the predetermined condition. More specifically, if the agent's performance is determined to satisfy the predetermined condition or, in other words, the agent's performance is determined to be favorable, then the second UI may be presented to the customer on the customer device. In at least one example embodiment, the second UI may include content requesting the customer to provide an endorsement for the agent so that the endorsement may be subsequently shared on one or more social media profiles maintained by the agent. In an example embodiment, the second UI may include a first free-flow text area capable of receiving a customer input related to the endorsement from the customer. Furthermore, the content in the second UI may prompt the customer to link the endorsement to a respective social media profile of the customer prior to posting of the endorsement on the one or more social media profiles of the agent. The provisioning of the endorsement as well as linking (or not linking) of the customer's social media profile to the endorsement may be performed as explained with reference to FIGS. 6 and 7.

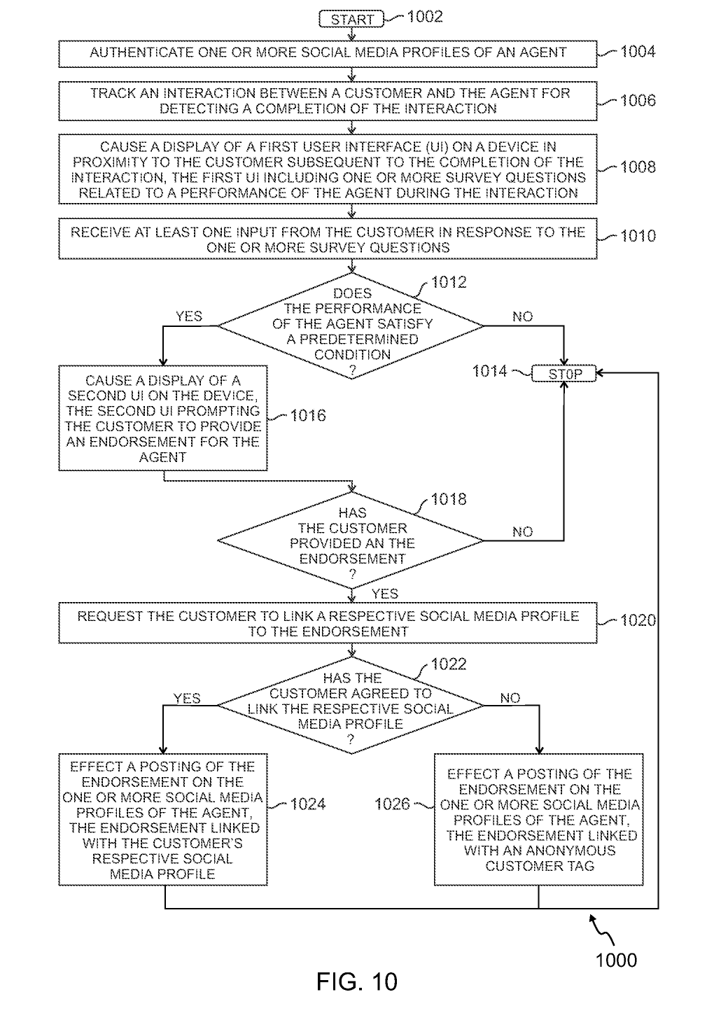

At operation 910 of the method 900, a posting of the endorsement on the one or more social media profiles of the agent is effected upon receiving the endorsement for the agent from the customer. The posting of the endorsement may be performed as explained with reference to FIG. 8 and is not explained again herein. Another method for facilitating social recognition of agents is explained with reference to FIG. 10.

FIG. 10 is a flow diagram of an example method 1000 for facilitating social recognition of agents, in accordance with an embodiment of the invention. The method 1000 depicted in the flow diagram may be executed by, for example, the system 200 explained with reference to FIGS. 2 to 8. Operations of the flowchart, and combinations of operation in the flowchart, may be implemented by, for example, hardware, firmware, a processor, circuitry and/or a different device associated with the execution of software that includes one or more computer program instructions. The method 1000 starts at operation 1002.

At operation 1004 of the method 1000, one or more social media profiles of an agent are authenticated.

At operation 1006 of the method 1000, an interaction between a customer and the agent is tracked for detecting a completion of the interaction.

At operation 1008 of the method 1000, a display of a first user interface (UI) is caused on a device in proximity to the customer subsequent to the completion of the interaction. The first UI includes one or more survey questions related to a performance of the agent during the interaction.

At operation 1010 of the method 1000, at least one input is received from the customer in response to the one or more survey questions.

At operation 1012 of the method 1000, it is determined whether the performance of the agent satisfies a predetermined condition. The determination of whether the performance of the agent satisfies the predetermined condition may be performed based on the at least one input. Operation 1014 is performed if it is determined that the performance of the agent does not satisfy the predetermined condition. At operation 1014 of the method 1000, the method 1000 stops. Operation 1016 is performed if it is determined that the performance of the agent satisfies the predetermined condition.

At operation 1016 of the method 1000, a display of a second UI is caused on the device. The second UI including content requesting the customer to provide an endorsement for the agent. Further, the customer is informed that the endorsement will be shared on the one or more social media profiles of the agent.

At operation 1018 of the method 1000, it is determined whether the customer has provided an endorsement. If it is determined that the customer has not provided an endorsement and closed the second UI, then operation 1014 is performed. If it is determined that the customer has provided an endorsement, then operation 1020 is performed.

At operation 1020 of the method 1000, the customer is requested to link a respective social media profile to the endorsement.

At operation 1022 of the method 1000, it is determined whether the customer has agreed to link the respective social media profile to the endorsement. If the customer has agreed to link the respective social media profile then operation 1024 is performed. At operation 1024 of the method 1000, a posting of the endorsement on the one or more social media profiles of the agent is effected and the endorsement is linked with the customer's respective social media profile.

If the customer has not agreed to link the respective social media profile then operation 1026 is performed. At operation 1026 of the method 1000, a posting of the endorsement on the one or more social media profiles of the agent is effected and the endorsement is linked with an anonymous customer tag. The method ends at operation 1014.

Without in any way limiting the scope, interpretation, or application of the claims appearing below, advantages of one or more of the exemplary embodiments disclosed herein facilitate social recognition of agents by posting customer endorsements on social media profiles of the agents. Favorable customer endorsements are shared in substantially real-time on an agent's social network and as such the endorsements are visible to family, friends and acquaintances of the agent. The endorsements displayed on the social media profiles of the agents allow family, friends and other acquaintances of the agents to also recognize the good services being provided by the agents, and open the agents to more appreciation outside the workplace. The endorsements may further be liked, commented upon, or shared by family and friends on the social media profiles of the agent. Such increased level of appreciation and social recognition of agents' efforts and customer handling by people external to the enterprises may contribute to increasing the productivity of the agents at the workplaces associated with the enterprises. Moreover, such real-time endorsements encourage the agents to do better in subsequent interactions as opposed to conventional techniques, which rely on periodic evaluations and appraisals for motivating the agents. Moreover, brand of an enterprise associated with the agents, which provides good services to the customers is also promoted as a result of such social recognition of their agents. Some embodiments of the invention are also applicable for provisioning testimonials/feedbacks by the customers for the agents, where the customers and the agents are involved in face-to-face interactions in merchant establishments.

Various embodiments described above may be implemented in software, hardware, application logic or a combination of software, hardware and application logic. The software, application logic and/or hardware may reside on one or more memory locations, one or more processors, an electronic device or, a computer program product. In an embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, as described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 200, the processor 202, the memory 204 and the I/O module 206 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIGS. 9 and 10). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations, which are different than those which, are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
causing, by a processor, a display of a first user interface (UI) on a device in proximity to a customer subsequent to a completion of an interaction of the customer with an agent, the first UI comprising one or more survey questions related to a performance of the agent during the interaction;
receiving, by the processor, at least one input from the customer in response to the one or more survey questions;
determining, by the processor, whether the performance of the agent satisfies a predetermined condition based on the at least one input;
causing, by the processor, a display of a second UI on the device if the performance of the agent is determined to be satisfying the predetermined condition, the second UI comprising content requesting the customer to provide an endorsement for the agent for subsequent sharing of the endorsement on one or more social media profiles maintained by the agent; and
effecting, by the processor, a posting of the endorsement on the one or more social media profiles upon receiving the endorsement for the agent from the customer.

2. The method of claim 1, wherein the one or more social media profiles are pre-approved by the agent for posting customer endorsements.

3. The method of claim 1, further comprising:
authenticating, by the processor, the one or more social media profiles prior to posting of the endorsement.

4. The method of claim 1, wherein at least one survey question from among the one or more survey questions corresponds to rating the performance of the agent on a preconfigured performance scale.

5. The method of claim 4, wherein determining if the performance of the agent satisfies the predetermined condition comprises determining if the rating is greater than a predetermined average rating on the preconfigured performance scale.

6. The method of claim 1, wherein the one or more survey questions are configured to facilitate generation of at least one score from among a net promoter score (NPS), a net experience score (NES) and a customer satisfaction (CSAT) score.

7. The method of claim 6, wherein determining whether the performance of the agent satisfies the predetermined condition comprises determining if the at least one score is greater than a predefined threshold value.

8. The method of claim 1, wherein the interaction is one of a voice call interaction, a face to face conversation and a textual chat interaction between the customer and the agent.

9. The method of claim 1, wherein at least one of the first UI and second UI corresponds to an interactive interface within a chat console.

10. The method of claim 1, wherein the device is one of a customer affiliated device, an agent device, an electronic device deployed at an enterprise location and a public display device.

11. The method of claim 1, wherein the second UI comprises a first free-flow text area capable of receiving a customer input related to the endorsement from the customer.

12. The method of claim 11, wherein the second UI comprises a second free-flow text area capable of receiving a textual input related to feedback for the agent from the customer.

13. The method of claim 1, further comprising:
requesting, by the processor, the customer to link the endorsement to a respective social media profile of the customer prior to the posting the endorsement on the one or more social media profiles of the customer, wherein the posted endorsement on the one or more social media profiles of the agent is linked to the respective social media profile of the customer upon receiving an acceptance from the customer for linking the endorsement to the respective social media profile of the customer.

14. The method of claim 13, wherein the posted endorsement is associated with a tag indicative of an anonymous customer if the customer rejects the request for linking the endorsement to the respective social media profile of the customer.

15. The method of claim 1, wherein the endorsement posted on the one or more social media profiles of the customer comprises at least one of textual content, image content and animation content.

16. A system, comprising:
at least one processor; and
a memory having stored therein machine executable instructions, that when executed by the at least one processor, cause the system to:
cause a display of a first user interface (UI) on a device in proximity to a customer subsequent to a completion of an interaction of the customer with an agent, the first UI comprising one or more survey questions related to a performance of the agent during the interaction;
receive at least one input from the customer in response to the one or more survey questions;
determine whether the performance of the agent satisfies a predetermined condition based on the at least one input;
cause a display of a second UI on the device if the performance of the agent is determined to be satisfying the predetermined condition, the second UI comprising content requesting the customer to provide an endorsement for the agent for subsequent sharing of the endorsement on one or more social media profiles maintained by the agent; and
effect a posting of the endorsement on the one or more social media profiles upon receiving the endorsement for the agent from the customer.

17. The system of claim 16, wherein the one or more social media profiles are pre-approved by the agent for posting customer endorsements.

18. The system of claim 16, wherein the system is further caused to:
authenticate the one or more social media profiles prior to posting of the endorsement.

19. The system of claim 16, wherein at least one survey question from among the one or more survey questions corresponds to rating the performance of the agent on a preconfigured performance scale.

20. The system of claim 19, wherein determining if the performance of the agent satisfies the predetermined condition comprises determining if the rating is greater than a predetermined average rating on the preconfigured performance scale.

21. The system of claim 16, wherein the one or more survey questions are configured to facilitate generation of at least one score from among a net promoter score (NPS), a net experience score (NES) and a customer satisfaction (CSAT) score.

22. The system of claim 21, wherein determining whether the performance of the agent satisfies the predetermined condition comprises determining if the at least one score is greater than a predefined threshold value.

23. The system of claim 16, wherein the second UI comprises a first free-flow text area capable of receiving a customer input related to the endorsement from the customer.

24. The system of claim 23, wherein the second UI comprises a second free-flow text area capable of receiving a textual input related to feedback for the agent from the customer.

25. The system of claim 16, wherein the system is further caused to:
request the customer to link the endorsement to a respective social media profile of the customer prior to the posting the endorsement on the one or more social media profiles of the customer, wherein the posted endorsement on the one or more social media profiles of the agent is linked to the respective social media profile of the customer upon receiving an acceptance from the customer for linking the endorsement to the respective social media profile of the customer.

26. The system of claim 25, wherein the posted endorsement is associated with a tag indicative of an anonymous customer if the customer rejects the request for linking the endorsement to the respective social media profile of the customer.

27. The system of claim 16, wherein the endorsement posted on the one or more social media profiles of the customer comprises at least one of textual content, image content and animation content.

28. A non-transitory computer-readable medium storing a set of instructions that when executed cause a computer to perform a method comprising:
causing a display of a first user interface (UI) on a device in proximity to a customer subsequent to a completion of an interaction of the customer with an agent, the first UI comprising one or more survey questions related to a performance of the agent during the interaction;
receiving at least one input from the customer in response to the one or more survey questions;
determining whether the performance of the agent satisfies a predetermined condition based on the at least one input;
causing a display of a second UI on the device if the performance of the agent is determined to be satisfying the predetermined condition, the second UI comprising content requesting the customer to provide an endorsement for the agent for subsequent sharing of the endorsement on one or more social media profiles maintained by the agent; and
effecting a posting of the endorsement on the one or more social media profiles upon receiving the endorsement for the agent from the customer.

29. The computer-readable medium of claim 28, wherein the method further comprises:
authenticating the one or more social media profiles prior to posting of the endorsement.

30. The computer-readable medium of claim 28, wherein at least one survey question from among the one or more survey questions corresponds to rating the performance of the agent on a preconfigured performance scale.

31. The computer-readable medium of claim 30, wherein determining if the performance of the agent satisfies the predetermined condition comprises determining if the rating is greater than a predetermined average rating on the preconfigured performance scale.

32. The computer-readable medium of claim 28, wherein the one or more survey questions are configured to facilitate generation of at least one score from among a net promoter score (NPS), a net experience score (NES) and a customer satisfaction (CSAT) score.

33. The computer-readable medium of claim 28, wherein the second UI comprises a first free-flow text area capable of receiving a customer input related to the endorsement from the customer.

34. The computer-readable medium of claim 33, wherein the second UI comprises a second free-flow text area capable of receiving a textual input related to feedback for the agent from the customer.

35. The computer-readable medium of claim 28, wherein the method further comprises:
requesting the customer to link the endorsement to a respective social media profile of the customer prior to the posting the endorsement on the one or more social media profiles of the customer, wherein the posted endorsement on the one or more social media profiles of the agent is linked to the respective social media profile of the customer upon receiving an acceptance from the customer for linking the endorsement to the respective social media profile of the customer.

36. The computer-readable medium of claim 35, wherein the posted endorsement is associated with a tag indicative of an anonymous customer if the customer rejects the request for linking the endorsement to the respective social media profile of the customer.

37. The computer-readable medium of claim 28, wherein the endorsement posted on the one or more social media profiles of the customer comprises at least one of textual content, image content and animation content.
